(19) United States
(12) Patent Application Publication
(10) Pub. No.: US 2018/0325768 A1
(43) Pub. Date: Nov. 15, 2018

(54) Apparatus and Method for a Unitary Body Suction with Contiguous Sealing Beveled Lip

(71) Applicant: Guylaine Cote, Vero, FL (US)

(72) Inventor: Guylaine Cote, Vero, FL (US)

(73) Assignee: Guylaine Cote, Vero, FL (US)

(21) Appl. No.: 15/145,564

(22) Filed: May 3, 2016

(51) Int. Cl. A61H 9/00; A61H 19/00

(52) U.S. Cl. CPC A61H 9/0057; A61H 2009/0064; A61H 19/34; A61H 19/32

(57) ABSTRACT

An apparatus and method for manufacturing of a pliable, unitary dome shaped suction apparatus, wherein the top end and side walls are contiguous without any apertures or extensions, and that radially terminate into a bottom end and sealing lip with a beveled edge for creating a secure seal with a skin surface. Furthermore, a negative pressure is created within the concavity of the vacuous dome and caused by squeezing of any one of, or combination, of the side wall, and, or top end of the vacuous dome. Additionally, the negative pressure is released by applying counter-pressure on any one of, or combination, of the sidewall, and, or top end of the vacuous dome to counteract the negative pressure within the vacuous dome and further causing release of the sealing lip from the contact surface.

### BACKGROUND

### Field

The field of the invention relates to a suction apparatus for attachment to a skin surface, and, more particularly the apparatus capable of securely forming a seal with a skin surface, wherein the suction is created by squeezing the bulb upon contact of the sealing lip and skin above the targeted tissue.

### Related Art

Cupping therapy is an ancient form of alternative medicine. The therapy is achieved by creating suction on the skin thus mobilizing the blood flow to a particular region on the body in order to promote healing. Suction can be created using mechanical devices such as hand or electrical pumps. The suction gently draws the skin upwards by creating a vacuum in a concavity of a cup over the target area of the skin. It alleviates and treats pain, increases oxygenation and tissue delivery, removes old stagnant blood, creates new blood vessels in the deep scar tissues in the muscles and connective tissue, muscle knots as well as swelling.

The current cupping methods include fire cupping method and the suction cupping method. In the fire cupping method, fire is used to increase the temperature of the interior of the cupping device. Once fire is ceased, the internal temperature of the cupping vessel decreases in an airtight state, and the pressure inside the cupping vessel decreases to lower than the atmospheric pressure. Thereby is generated suction force. However, inexperienced personnel are likely to cause burn injuries on patients when using the fire cupping method. In the conventional suction cupping method, a manual or mechanical device is used to suck the air inside a cupping vessel. However, only the patient himself knows what extend of suction his skin can tolerate. Therefore, the cupping pressure is hard to control to an optimal state except the patient operates the suction device by himself.

A number of cupping therapy apparatuses and methods have been provided in the prior art, nevertheless, they differ from the present invention in that neither claim or disclose an apparatus or method embodying a device for cupping therapy that is a unitary pliable apparatus with a sealing lip which has an outer beveled edge that can easily create a negative pressure on any part of the body; that lacks an outlet or valve; and that lacks the traditional air-displacement assembly to achieve the negative pressure or suction within the housing of the cup, such as a displacement rod or electro-mechanical means.

### SUMMARY

These and other features and improvements of the present application will become apparent to one of ordinary skill in the art upon review of the following detailed description when taken in conjunction with the several drawings and the appended claims.

The present invention fills a void left behind by the current art by providing for an apparatus and method for manufacturing and use of a pliable, unitary dome shaped suction apparatus, wherein the top end and side walls are contiguous without any apertures or extensions, and that radially terminate into a bottom end and sealing lip with a beveled edge for creating a secure seal with a skin surface. Furthermore, a negative pressure is created within the concavity of the vacuous dome and caused by squeezing of any one of, or combination, of the side wall, and, or top end of the vacuous dome.

Yet in another exemplary objective of the invention, the negative pressure created between the user's skin and the lip of the suction apparatus, is created in concavity of the dome shaped apparatus. Additionally, the negative pressure is released by applying counter-pressure on any one of, or combination, of the sidewall, and, or top end of the vacuous dome to counteract the negative pressure within the vacuous dome and further causing release of the sealing lip from the contact surface.

Another objective of the present invention is to provide cupping therapy using a pliable unitary dome shaped cupping apparatus for all ages, genders, physical states, mental states, diseases, seriousness of diseases, cupped regions, flatness of cupped regions, tissue robustness of cupped regions, size of cupped regions, and acupoints on cupped regions, whereby the therapy is adapted to the physical conditions of the patient.

Still another objective of the present invention is to provide an instant suction between the cupping apparatus and the skin by mechanical forces such as the force exerted by the fingers of a user thus, providing different sucking forces for different regions of the human body and additionally, can precisely control the duration of cupping.

Other devices, apparatus, and/or products according to embodiments will be or will become apparent to one of ordinary skill in the art upon review of the following drawings and further description. It is intended that all such additional devices, apparatus, and/or products be included within this description, be within the scope of the present invention, and be protected by the accompanying claims. Furthermore, additional aspects and advantages of this invention may be realized in other applications, aside from the intended application of human health and wellness. Other pertinent applications that may exploit the aspects and advantages of this invention are: occupational therapy/rehabilitation, adult nursing homes.

### BRIEF DESCRIPTION OF DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

FIG. 1 is a side perspective view diagram of an apparatus in accordance with an aspect of the invention.

FIG. 2 is a bottom up side perspective view diagram of the apparatus in accordance with an aspect of the invention.

FIG. 3 is a bottom up sectional view diagram of the sealing lip with narrow mouth opening.in accordance with an aspect of the invention.

FIG. 4 is a bottom up sectional view diagram of the sealing lip with a wide mouth opening in accordance with an aspect of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

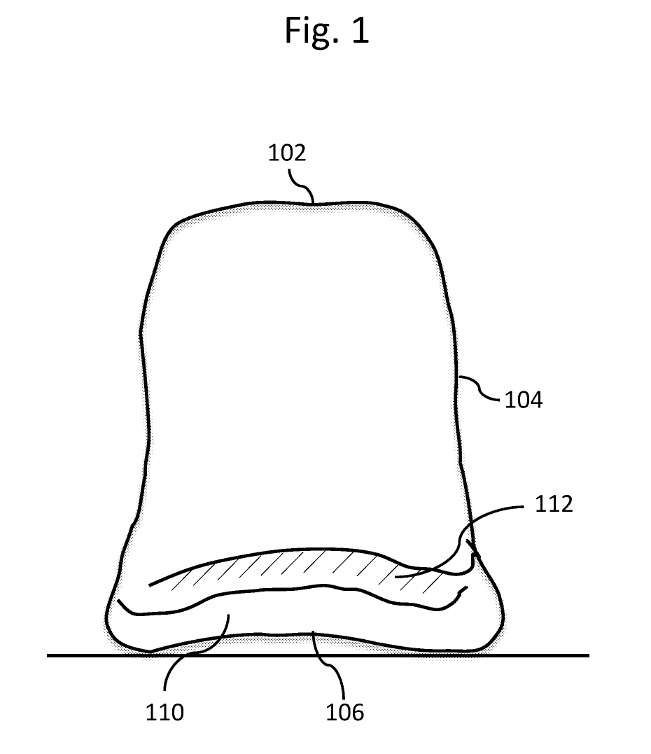

Now in reference to FIG. 1, this depicts the pliable suction apparatus in accordance with an aspect of the invention. In a preferred embodiment, a vacuous dome 100 may have a top end 102 with a bulbous housing. However, top ends 102 with other shaped housing may be provided. The top end 102 bulbous housing may radially extend downward into a but not limited to a, circumferential concave side wall 104 to form a vacuous dome 100 shaped structure. For example, in alternative embodiments, any one of or a combination of, but not limited to a square or rectangular top end may extend downward into a plurality of flat, four-sided side walls. The pliable suction apparatus may have a bottom end 106 that is disposed with a mouth (not shown) surrounded by a sealing lip 110 of discretionary size and shape, depending on the purpose of use. The mouth (not shown) may be configured to allow air to pass into and, or out of the vacuous dome 100. The mouth (not shown) may have varying opening or circumferential sizes depending on the purpose of use. For instance, a suction apparatus intended for a larger skin surface area, such as a belly, chest, neck, back, legs, arms, may require a larger opening mouth (not shown), yet a thinner sealing lip 110 for forming a tight sealing contact with the skin surface. Suction apparatus intended for a smaller skin surface area, such as a toe or finger, may require a smaller opening mouth (not shown), and yet a thicker sealing lip 110. Alternatively, the converse may be required, wherein the smaller apparatus is intended for a smaller skin surface area demands a smaller opening, but a thinner sealing lip 110. Likewise, the larger apparatus intended for larger skin surface area demands a larger opening, but a thicker sealing lip 110. There are no other apertures or outlets disposed on the contiguous, unitary construction, aside from the mouth (not shown).

The mouth (not shown) may be surrounded by the sealing lip 110. The sealing lip 110 may have a beveled outer edge, or a brim 112. The size and axial tilt of the bevel may vary depending on the purpose of the use. For instance, the size of the bevel and degree of the axial tilt may be larger for smaller apparatus. Alternatively, apparatus intended for larger skin surface areas may have the larger bevel size and higher degree of axial tilt.

Still in reference to the sealing lip 110, in a preferred embodiment, the lip may be composed of any one of, a rubber silicon composition. Alternatively, any one of a highly pliable, thermoplastic polymer may be used for the lip composition. Moreover, the sealing lip 110 and the vacuous housing may be a unitary, contiguous construction. There may be no columnar extensions, protrusions, apertures; nor any disposable, collapsible, or modular elements.

The sealing lips 110 composition, dimension, and design are configured to form a seal with a contact surface by using a negative pressure created within the vacuous dome 100. A user may squeeze any one of, or combination, of the side wall 104, and, or top end 102 of the vacuous dome 100 using any one of or a combination of mechanical force, electromechanical force exerted by the user. In yet another alternative embodiment, the negative pressure may be created by suctioning the air within the vacuous dome 100 by user inhalation, or by any other suctioning means.

Once the sealing contact is formed, the suction cup is secured to the skin or tissue. The housing top end 102 and side wall 104 may be movable due to the pliable nature of the silicon rubber or thermoplastic polymer composition. The bottom end 106, mouth (not shown), and sealing lip 110 may be stationary in relation to the contact surface as a result of the contact seal. Alternatively, the contact seal may be sufficiently strong to maintain the negative pressure within the housing, but yet still slidably disposed on the skin or tissue. The slidable disposition may be achieved by the application of any one of a lubricant on the sealing lip 110, or the continuous or discrete secretion of any one of a lubricant from an outlet operatively coupled to a housing disposed within the lip or vacuous dome 100.

The sealing contact may be reversed by applying counter-pressure on any one of, or combination, of the sidewall 104, and, or top end 102 of the vacuous dome 100 to counteract the negative pressure within the vacuous dome 100 and further causing release of the sealing lip 110 from the contact surface. Alternatively, the bottom end 106 may release from the contact surface by removing the sealing lip 110, with or without the aid of a solvent from the contact surface. In other embodiments, the contact seal may be removed by other means, such as electromechanical means, for counteracting the negative pressure within the vacuous dome 100 and further causing release of the sealing lip 110 from the contact surface. In yet other alternative embodiments, an electromechanical means may be disposed for actuating the release of the sealing lip 110 from the contact surface. Moreover, an electromechanical means may be disposed for the discrete release of a sealing lip release solvent.

In alternative embodiments (not shown in FIG. 1), the unitary suction apparatus may be used any one of, or a combination of, but not limited to in a medical, therapeutic, sexual industry as well as veterinary health. While not shown in FIG. 1, the unitary suction apparatus can be used in two styles—wet and dry. With the wet cupping, both the part of the body that is being cupped—as well as the edge of the sealing lip of the cupping apparatus are coated with a lubricant. The lubricant may be any one of, or a combination of, but not limited to oil, lotion, gel, cream. Additionally, the lubricant helps the unitary suction apparatus slide over the body and creating a tighter seal between the contact surface and the sealing lip. Furthermore, dry cupping may be performed without the use of a lubricant.

In another alternative embodiment of the present invention, the unitary suction apparatus may be placed on both, but not limited to, male and female genital organs to increase sexual pleasure, any and all forms of BDSM and sexual play. Additionally, in yet another alternative embodiment, the suction apparatus may be also used to remove poison from the skin surface after an insect sting.

While not shown in FIG. 1, the sealing lip may be disposed with any one of, or combination of, a pressure, cortisol, lactate, and, or bioimpedance sensor. In further detail, at least one embedded sensor for capturing a physiological data input from a user is provided. Additionally, an interface means for transmitting the data from the sensor to a storage and, or processor means, over a network. Finally, based on the said data, provide any one of, or combination of, a health tracking function, user history function, network sharing function, and personalized recommendation function. For instance, a user may input certain physical, physiological, pathological, environmental, and, or contextual parameters, which may layer onto already existing contextual data and accruing real-time sensor data, to provide richer and contextualized health and wellness recommendations. The embedded sensor may be any one of, or combination of, a gyroscopic sensor, an accelerometer sensor, pressure, cortisol sensor, electrical impulse, respiration, bioimpedance, optical, and, or lactate sensor. In other embodiments, a suite of sensors may be provided that also real-time monitor physiological parameters, such as respiration rate, heart rate, cortisol levels. Bioimpedance sensors may be fitted onto the sealing lip or vacuous housing, wherein an electrical impulse is directed onto the tissue of a user and differences in electrical potential represent the raw data for processing the above physiological parameters.

Embodiments may include the addition of a remote server to provide for back-end functionality and support. The server may be situated adjacent or remotely from the system and connected to each system via a communication network. In one embodiment, the server may be used to support verification or authentication of a user and a mobile device application function. In authenticating a user, a server may be further caused to recognize the user device at a particular system component, or any other system component that may be able to house a unique short-range communication tag. The server may identify and authenticate the particular component and user device by recognizing the unique tag, and then, authenticate the user by identifying the user device located at the particular component. The unique, short-range tag may be a NFC tag, RFID chip, Bluetooth, ZigBee, or any short-range communication protocol standard. The remote server may be further configured to support a user history function; a network sharing function; and support a health and wellness search engine. The remote server may be further configured to provide a user-control system, which authenticates the user and retrieves usage data of the user and applies the data against a predefined criterion of use.

Other embodiments may include a remote server that is configured to provide a contextually-aware suggestion engine, which may access the user history function and at least one user contextual information to cause the processor to display a suggested output on at least one display interface. Provisioning of the remote server may be delivered as a cloud service. In yet other embodiments, a suction apparatus may be associated with an Internet of Things, whereby the suction apparatus is fully integrated into a user's home/gym/facility automation system, thereby providing additional contextual information for a contextually-aware health and wellness suggestion engine.

Also not shown in FIG. 1, the sealing lip and, or vacuous housing may disposed with any one of electro, and, or magneto therapy delivery means for delivering therapeutic pulses onto a skin surface and underlying tissue. Therapeutic pulses may be delivered in continuous fashion or in a discreet fashion.

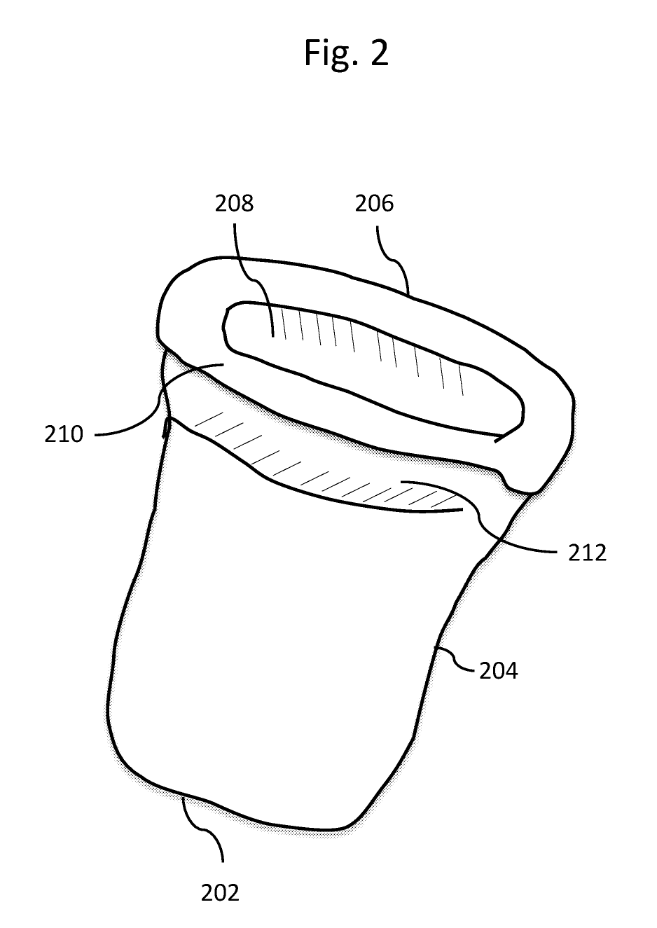

Now in reference to FIG. 2, a bottom elevation view of the pliable suction apparatus in accordance with an aspect of the invention is shown. In a preferred aspect of the invention, the pliable suction apparatus may be comprised of pliable, elastomeric, and hypo-allergenic material. The pliable suction apparatus may be configured to allow the top end 202, the bottom end 206, mouth of the sealing lip 208, concave circumferential side wall 204 and along with the beveled outer edge 212 of the sealing lip 210 to conform to the shape of specific areas of the patient. For instance, the dimension, shape, thickness, tilt, and bevel of the sealing lips 210 may be fundamentally specific to the intended target area. The suction apparatus may be made of a heat-settable thermoplastic material with “memory” such that it does not take a substantially permanent formation under a specific patient load.

The pliable suction apparatus may have at least one aperture in designated regions of the pliable suction apparatus. Apertures serve to alleviate contact pressure in targeted areas, while still maintaining sufficient pressure for suction. Alternate aspects of the invention may be for a pliable suction apparatus with multiple apertures corresponding to the aforementioned contact pressure regions. In another embodiment of the invention, the pliable suction apparatus may appear as one contiguous piece, comprising at least one break away aperture located at a designated contact pressure region. In this embodiment, users or healers could have the choice of removing break away apertures as the user or healer sees fit. In yet other embodiments, the tensile strength of the suction apparatus may vary across the surface of the suction apparatus, depending on the load-bearing regions.

In a preferred embodiment, the sealing lip 210 of the pliable suction apparatus may be impregnated, coated, embedded, lined or double layered with an antibiotic of proven safety and efficacy. The antibiotic may be coupled with a cream, or other viscous material, for the uniform distribution over the surface of the intended target area. Additionally, in an alternative embodiment, the suction apparatus may be impregnated, coated, embedded, lined, double layered, or spread with any therapeutic or prophylactic of proven safety and efficacy.

While also not shown in FIG. 2, the sealing lip 210 may be embedded or disposed with any one of a mechanical means for delivery of any one of a therapeutic agent in any one of an immediate, delayed, intermittent, single, and, or consistent release. Alternatively, the sealing lip 210 may be embedded with any one of an electromechanical means for actuating release of a therapeutic agent in any one of an immediate, delayed, intermittent, single, and, or consistent release.

In yet another embodiment of the invention, an electronic motor with spider-like or finger-like projections may be embedded in any one of, or a combination of, the top end 202, circumferential concave side walls 204 of the unitary suction apparatus for enhancing blood flow to any body part, thus preventing atrophy and gangrene for travelers in extreme cold temperatures. The unitary suction apparatus with the embedded electronic motor may be inserted into any one of, or a combination, but not limited to, clothing for example, gloves, socks, hats, mittens, shoes, clothing and, or pockets. Additionally, the unitary suction apparatus may also be used for, but not limited to, for enhancing blood flow for diabetic patients as wells as older geriatric patients for prevention of any one of, or a combination of, but not limited to, for limb and, or distal ischemia. Furthermore, in yet another embodiment of the invention, the unitary suction apparatus may also be used in any one of, or a combination of, but not limited to, nursing homes, hospitals, maternity wards, mid-wife institutions for the stimulation of lactation.

Again not shown in FIG. 2, is a sealing lip 210 that may be impregnated, coated, embedded, lined or double layered with a lubricating agent, such as an oil, which allows for the suction apparatus to be slidably disposed on the contact surface. Alternatively, the sealing lip 210 may be disposed with any one of a mechanical means for delivery of any one of a lubricating agent in any one of an immediate, delayed, intermittent, single, and, or consistent release. In yet other alternative embodiments, the sealing lip 210 may be disposed with any one of an electro-mechanical means for actuating release of any one of a lubricating agent in any one of an immediate, delayed, intermittent, single, and, or consistent release.

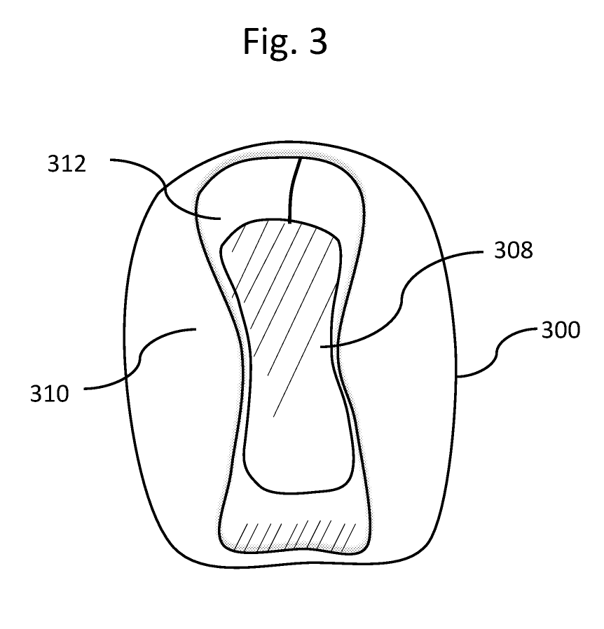

Now in reference to FIG. 3, which depicts a cross sectional view of the sealing lip 310 with a narrow mouth 308 opening and a wide lip. In a preferred embodiment of the invention, a sealing lip 310 sits at the bottom end of the dome 300 and is surrounded by the mouth 308 further comprising of a beveled outer edge 312, oblong dimension and may be composed any one of, or a combination of, but not limited to a rubber-based, silicone-based and, or latex-based composition. The sealing lip 310 and the vacuous dome 300 are a unitary piece, further configured to form an air-tight seal with a contact surface by using a negative pressure created within the vacuous dome 300.

In a preferred embodiment of the present invention, the mouth 308 may have a narrow opening or varying circumferential sizes depending on the purpose of use.

Furthermore, suction apparatus intended for a smaller skin surface area, such as a toe or finger, may require a smaller opening mouth 308, and yet a thicker sealing lip 310. Alternatively, in another embodiment of the invention, converse may be required, wherein the smaller suction apparatus intended for a smaller skin surface area demands a smaller opening, but a thinner sealing lip 310.

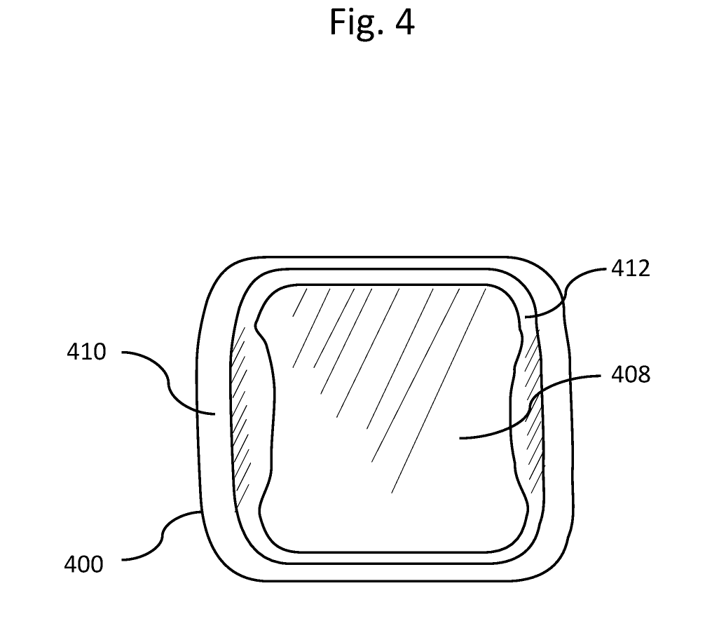

Now in reference to FIG. 4, which depicts a cross sectional view of the sealing lip 410 with a wide mouth 408 opening and a narrow lip 410. In a preferred embodiment of the invention, a sealing lip 410 sits at the bottom end of the dome 400 and is surrounded by the mouth 408 further comprising of a beveled outer edge 412 in oblong dimension and may be composed any one of, or a combination of, but not limited to a rubber-based, silicon-based and, or latex-based composition. In a preferred embodiment of the present invention, the mouth 408 may have a wide opening or circumferential size depending for the purpose of use.

Furthermore, suction apparatus intended for a larger skin surface area, such as arms, legs, torso, require a larger opening mouth 408, and a thinner sealing lip 410. Alternatively, in another embodiment of the invention, the converse may be required, wherein the larger cups intended for a smaller skin surface area demands a larger opening, but a thinner sealing lip 410.

In yet another preferred embodiment of the present invention, the mouth 308, 408 may be surrounded by the sealing lip 310, 410. The sealing lip 310, 410 may have a beveled outer edge, or a brim 412. The size and axial tilt of the beveled edge 312, 412 may vary depending on the purpose of the use. For instance, the size of the bevel and degree of the axial tilt may be larger for smaller cups and vice versa.

In yet another preferred embodiment of the invention, the sealing lip 310, 410 may be composed of any one of, a rubber silicon composition. Alternatively, any one of a highly pliable, thermoplastic polymer may be used for the lip composition. Additionally, the sealing lip 310, 410 and the vacuous dome 300, 400 may be a unitary, contiguous construction without columnar extensions, protrusions, apertures; nor any disposable, collapsible, or modular elements.

In yet another preferred embodiment of the present invention, the sealing lip 310, 410 composition, dimension, and design are configured to form a seal with a contact surface by using a negative pressure created within the vacuous dome 300, 400. A user may squeeze any one of, or combination, of the side wall (not shown), and, or top end (not shown) of the vacuous dome 300, 400 using any one of, or a combination of mechanical force, electromechanical force exerted by the user.

In yet another alternative embodiment, the negative pressure may be created by suctioning the air within the vacuous dome 300, 400 by any one of, or a combination of, user inhalation, or by any other suctioning mechanisms.

Additionally, once the sealing contact is formed between the beveled lip edge 312, 412 and the skin, the vacuous dome 300, 400 is secured to the skin or tissue. The housing top end (not shown) and the side wall (not shown) may be movable in any direction due to the pliable nature of the silicon rubber or thermoplastic polymer composition. The bottom end 306, 406, mouth 308, 408, and sealing lip 310, 410 may be stationary in relation to the contact surface as a result of the contact seal. Alternatively, the contact seal may be sufficiently strong to maintain the negative pressure within the housing, but yet still slidably disposed on the skin or tissue. The slidablility may be achieved by the application of any one of a lubricant on the sealing lip 310, 410, or the continuous or discrete secretion of any one of a lubricant from an outlet operatively coupled to a housing disposed within the lip or vacuous dome 300, 400.

The sealing contact between the skin and the beveller edge 312, 412 of the sealing lip 310, 410 may be reversed by applying counter-pressure on any one of, or combination, of the sidewall (not shown), and, or top end (not shown) of the vacuous dome 300, 400 to counteract the negative pressure within the vacuous dome 300,400 and further causing release of the sealing lip 310, 410 from the contact surface. Alternatively, the bottom end (not shown) may release from the contact surface by removing the sealing lip 310, 410, with or without the aid of a solvent from the contact surface.

In other embodiments, the contact seal may be removed by other means, such as electromechanical means, for counteracting the negative pressure within the vacuous dome 300, 400 and further causing release of the sealing lip 310, 410 from the contact surface. In yet other alternative embodiments, an electromechanical means may be disposed for actuating the release of the sealing lip 310, 410 from the contact surface. Moreover, an electromechanical means may be disposed for the discrete release of a sealing lip release solvent.

Furthermore, in yet another embodiment of the current invention, the pliable, unitary suction apparatus may be of varying sizes wherein, the dome 100, 200,300, 400 may be any one of, or a combination of an irregular shape, symmetrical shape, hourglass shape, may have slight imperfections as well as dents on the walls. Additionally, the sealing lip 310, 410 may be of varying sizes wherein, the beveled edge 312, 412 may be any one of, or a combination of an irregular, thick, thin, symmetrical, hourglass shape or may have slight imperfections as well as dents.

The following details the method of manufacturing of the apparatus in accordance with an aspect of the invention. In a preferred embodiment, the method of manufacture of the unitary suction apparatus comprises the following steps: (1) inserting putty mix into a suction-shaped clay cup to create a putty cup; (2) lacing the clay cup with putty cup into the center of a container and filling the container and pouring molding clay into the container; (3) inserting three sticks in an upright position on each of the three sides of the poured molding clay in the container, and one stick in a flat position on the dome-side of the poured molding clay in order to form an injection track once it becomes a dried cast; (4) repeating step three for the second clay mold, forming each part of the two-part clay molding cast; (5) curing the two-part clay molding cast; (6) removing the suction-shaped clay cup and sticks, while the putty cup remains in the cured two-part clay molding cast; (7) fastening each part of the two-part clay molding cast on top of each other by re-inserting sticks through prior stick holes, so each stick traverses each part of the two-part clay molding cast and clamping to form a tight seal; (8) injecting via the injection track, an elastomeric polymer material in a gel state, such that once hardened, forms to the contours of the unitary suction cup with a sealing lip with a beveled edge; and (9) opening the molding cast to expose elastomeric-based suction cup and putty cup, and removing the putty cup to isolate the elastomeric unitary suction cup with a contiguous sealing lip.

Alternatively, 3D printing technology may also be a viable and an affordable alternative to injection production methods. The steps involved in 3D printing technology may be comprised of: (1) producing a 3-D model using computer-aided design (CAD) software, (2) convert the CAD drawing to the STL (standard tessellation language) format, (3) transfer to AM machine and STL file manipulation thereby designating the size and orientation for printing, (4) preparing the machine for a new print job including, but not limited to, refilling polymers, binders, tray to serve as a foundation and other consumables for the printer use, (5) building the prototype, (6) removing the printed object from the printer and (7) post-processing the printed object including, but not limited to, brushing off any remaining powder or bathing the printed object to remove water-soluble supports.

While this specification contains many specific execution details, these should not be interpreted as limitations on the scope of any inventions or of what may be claimed, but rather as descriptions of features specific to particular embodiments of particular inventions. Certain features that are described in this specification in the context of separate embodiments can also be implemented in combination in a single embodiment. Contrariwise, various features that are described in the context of a single embodiment can also be implemented and interpreted in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A pliable unitary suction apparatus comprising:
a vacuous dome comprising:
a bulbous top end;
a circumferential concave side wall;
a bottom end disposed with a mouth configured to allow air to pass into and, or out of the vacuous dome;
said bulbous top end radially extending down through the circumferential concave side wall and terminating at said bottom end to form a unitary vacuous dome; and
a sealing lip with a beveled outer edge surrounding the mouth,
wherein the sealing lip has an oblong shape; and
the sealing lip and the vacuous dome is a unitary piece, further configured to form a seal with a contact surface by using a negative pressure created within the vacuous dome and caused by squeezing of any one of, or combination, of the side wall, and, or top end of the vacuous dome; and
wherein the seal is reversed by applying counter-pressure on any one of, or combination, of the sidewall, and, or top end of the vacuous dome to counteract the negative pressure within the vacuous dome and further causing release of the sealing lip from the contact surface.

2. The device of claim 1, wherein the composition of the vacuous dome is a pliable elastomeric material including, any one of, or combination of rubber-based, latex-based or silicone based.

3. The device of claim 1, wherein the sealing lip is dimensioned in an irregular shape including any one of an oval and, or hour-glass.

4. The device of claim 1, wherein the sealing lip is configured to secure an airtight contact seal on any part of the human and, or for veterinary use.

5. The device of claim 1, wherein the suction depends on the amount of air in the dome.

6. The device of claim 1, wherein the negative pressure is created within the vacuous dome by a pumping effect produced by squeezing the dome in any direction by a mechanical and, or electro-mechanical force.

7. The device of claim 1, wherein the apparatus may be of at least two sizes.

8. The device of claim 1, wherein the sealing lip is embedded with any one of a therapeutic agent and releases said agent in any one of an immediate, delayed, intermittent, single, and or consistent release.

9. The device of claim 1, wherein the sealing lip is embedded with any one of a lubricating agent, including any one of, or combination of, oil, lotion, gel and, or cream.

10. The device of claim 1, wherein the sealing lip and, or vacuous dome is disposed with any one of, or combination of, a pressure, cortisol, lactate, bioimpedance, and, or a sensor for monitoring blood flow.

11. The device of claim 1, further comprising:
at least one embedded sensor for capturing a physiological data input;
an interface means for transmitting the data from said sensor to a storage and, or processor means, over a network; and
based on the said data and a user input data, provide any one of, or combination of, a health and wellness tracking function, user history function, network sharing function, and, or a personalized recommendation function.

12. The device of claim 1, wherein a health and wellness training program is based on any one of, or combination of, the health and wellness tracking function, user history function, network sharing function, and personalized recommendation function from any one of, or combination of, a sensor data input and, or user data input.

13. The device of claim 1, wherein the sealing lip and, or vacuous dome is disposed with any one of an electro, and, or magnetic signal delivery therapy unit.

14. A method of manufacturing a unitary suction apparatus, comprising the steps of:
inserting putty mix into a suction-shaped clay cup to create a putty cup;
placing the clay cup with putty cup into the center of a container and filling the container and pouring molding clay into the container;
inserting three sticks in an upright position on each of the three sides of the poured molding clay in the container, and one stick in a flat position on the dome-side of the poured molding clay in order to form an injection track once it becomes a dried cast;
repeating the third step for the second clay mold, forming each part of the two-part clay molding cast;
curing the two-part clay molding cast;
removing the suction-shaped clay cup and sticks, while the putty cup remains in the cured two-part clay molding cast;
fastening each part of the two-part clay molding cast on top of each other by re-inserting sticks through prior stick holes, so each stick traverses each part of the two-part clay molding cast and clamping to form a tight seal;
injecting through the injection track, an elastomeric polymer material in a gel state, such that once hardened, forms the contours of the unitary suction cup with a sealing lip with a beveled edge; and
opening the molding cast to expose elastomeric-based suction cup and putty cup, and removing the putty cup to isolate the elastomeric unitary suction cup with a contiguous sealing lip.

15. The method of claim 14, further comprising the step of: using a pliable elastomeric material including, any one of, or combination of, a rubber-based, latex-based or silicone based composition for the elastomeric unitary suction cup.

16. The method of claim 14, further comprising the step of:
molding the sealing lip in an irregular shape, including any one of an oval and, or hourglass shape and configured to secure an airtight contact seal on any part of a human and, or animal body.

17. The method of claim 14, further comprising the step of: including an elastomeric unitary suction cup of at least two sizes, to be secured on any part of a human and, or animal body.

18. The device of claim 1, further comprising the step of: disposing or embedding on the sealing lip and, or vacuous dome with any one of, or combination of, a pressure, cortisol, lactate, bioimpedance, and, or a sensor for monitoring blood flow.

19. The method of claim 14, further comprising the step of:
disposing or embedding at least one sensor for capturing a physiological data input;
providing an interface means for transmitting the data from said sensor to a storage and, or processor means, over a network; and
pushing or pulling any one of, or combination of, a health and wellness tracking function, user history function, network sharing function, and, or a personalized recommendation function to or from a user interface based on the said data and a user input data.

20. The method of claim 14, further comprising the step of: health and wellness training program is based on any one of, or combination of, the health and wellness tracking function, user history function, network sharing function, and personalized recommendation function from any one of, or combination of, a sensor data input and, or user data input.
